(19) United States
(12) Patent Application Publication
(10) Pub. No.: US 2007/0039489 A1
(43) Pub. Date: Feb. 22, 2007

(54) Material immersion apparatus

(76) Inventor: Lionel Gordon Evans, Auckland (NZ)

Correspondence Address: JACOBSON HOLMAN PLLC, 400 SEVENTH STREET N.W., SUITE 600, WASHINGTON, DC, 20004, US

(21) Appl. No.: 10/555,070

(22) PCT Filed: Apr. 19, 2004
(86) PCT No.: PCT/NZ04/00074

§ 371 Date: Nov. 6, 2006

(30) Foreign Application Priority Data
Apr. 28, 2003 (NZ) 525525

(51) Int. Cl. A23B 4/00

(52) U.S. Cl. 99/516

(57) ABSTRACT

Apparatus method of treating vegetables, fruit pieces, etc by immersing them deeply in a liquid bath of inverted “j” shape (1) holding vertically arranged endless conveyor (2). Material fed by conveyor (8) drops onto perforated flight (3A) of conveyor (2) at a region where it is above liquid level (5). During subsequent descent of flight (3A), buoyant material, e.g. apple slices, tends to rise through the liquid but is forced down by following flight or paddle (3B). After rounding bottom turn (4) the material, confined by flights (3) is uplifted until it is discharged from reservoir (1) for a subsequent treatment.

This is a nationalization of PCT/NZ04/000074 filed Apr. 19, 2004 and published in English.

### TECHNICAL FIELD

The present invention relates to apparatus, methods, uses and products capable of providing a liquid dipping process for material or material(s) (“material(s)”). More particularly although not solely the invention utilises an inverted flighted endless conveyor to lower and uplift the material(s) and to hold the material(s), if buoyant with respect to the liquid, to force the material(s) under the liquid prior to uplifting the material(s) thereform.

### BACKGROUND ART

Rotary paddled systems have hitherto been utilised in a bath, the wall of which assumes a form similar to that of the locus of the distal part of the paddles of the rotary wheel.

The present invention appreciates however that such paddle wheel systems provide a transitory immersion only where by necessity (where there is to be both a gravity assisted loading zone and a gravity assisted discharge zone from the paddle wheel) there is a keeping of the liquid level below the rotational axis.

The present invention recognises a significant advantage can arise from the use of a flighted endless conveyor in that it has the prospect of providing a longer dwell time in liquid without reliance on a greater volume of liquid over that which might be used in a paddled wheel immersion system. Moreover the present invention recognises an advantage can occur at the discharge zone from such a conveyor when inverted owing to the prospect that such an endless conveyor can provide a discharge zone which is more positive in allowing the falling of already immersed materials therefrom.

It is therefore an object of the present invention to provide apparatus, methods, uses, etc. which will at least go someway to take one or more advantage from the use of a flighted endless conveyor for the purpose of material immersion in a liquid.

As used herein the term “liquid” includes any fluid which has a liquid component, i.e. it can include mixtures of liquids, solutions, suspensions, emulsions, suspo-emulsions, etc.

### DISCLOSURE OF INVENTION

In one aspect the invention consists in apparatus for immersing material or materials (“material(s)”) in a bath, [said material(s) being preferably buoyant with respect to liquid of the bath], said apparatus comprising or including

a bath or reservoir (“reservoir”) containing or to contain said liquid,

a flighted endless conveyor that serially present flights to a loading zone where each flight serially flight receives thereon material(s) to be immersed in the liquid of the bath and later presents material(s) initially received by the preceding flight to a discharge zone from whence the material(s) leave the flight,

wherein the loading zone to discharge zone involves an initial flight supported lowering of the materials down to the bath and thereafter a following flight carriage of the material(s) and/or liquid in the bath until such time as the materials are supported by said following flight out of the liquid of the bath and carried at least in part thereby to the discharge zone at which the materials cascade from said following flight.

The reservoir can have provision for flow through or replenishment.

Preferably the discharge zone involves a gravity supported cascading of the materials from said following flight to a separate liquid to that of said bath.

Preferably each flight at least substantially completely occludes a passageway through the bath defined by the conveyor and the reservoir.

Preferably the locus of movement of the endless conveyor is that of an inverted conveyor preferably substantially in the form of an inverted “j”, the loading zone being at a region beyond the crook of the inverted “j” down which the flights move substantially on a vertical locus prior to ascending on the opposite side of the stem of the “j” and then into the overhang zone of the inverted “j” at which there is the discharge zone.

Preferably in other forms banana or other type circuit type shapes are contemplated irrespective of whether or not there is a vertical or near vertical descending from the loading zone, irrespective of whether or not there is a vertical or near vertical ascending from the lower most zone and irrespective of whether or not there is any overhand (and irrespective of any concavity or not in the locus).

In yet a further aspect the present invention consists in the use of a (or an inverted) flighted endless conveyor for the purpose of immersing materials in a bath, e.g. of a dipping liquid.

Preferably the materials are buoyant in the liquid of the bath and an underside of flights of the conveyor lowers the material in the liquid at least after an initial contacting of the liquid by the materials, e.g. preferably they are lowered on the upper side of the flight preceding the underside of the following flight.

By way of example only such immersion can be of apple pieces, e.g. during a process as in PCT/NZ02/00168.

Preferably the bath conforms at least in part to those regions of the conveyor that are to low the materials to carry the materials through and uplift the materials from the liquid.

In yet a further aspect the present invention consists in the use of apparatus of any of the kinds in accordance with the present invention for the purpose of dipping vegetable and/or fruit material in an appropriate dipping solution.

In still a further aspect the present invention consists in dipping apparatus substantially as herein described with reference to any one or more of accompanying drawings.

In yet a further aspect the present invention consists in a method of dipping materials when performed substantially as herein described with reference to any one or more of the accompanying drawings or the description generally.

In yet a further aspect the present invention consists in a method of treating vegetable and/or fruit materials which comprises or includes immersing the materials in a treating liquid under the action of a flighted endless belt conveyor.

Preferably an underside of one flight contacts, during at least an initial part of the immersion process in a bath, at least some of the materials which prior to immersion were lowered on the upper side of the flight preceding said one flight.

The invention also consists in materials treated by a method or apparatus of the present invention.

### BRIEF DESCRIPTION OF DRAWINGS

A preferred form of the present invention will now be described with reference to the accompanying drawing in which,

FIG. 1 is a side view of an inverted (an inverted J shaped locus) and flighted endless belt conveyor having an infeed loading zone for materials (such as apple slices) and having a discharge zone which under gravity drops the materials into a like or, as shown, a conventional paddle wheel type immersion apparatus for a secondary immersion process, and

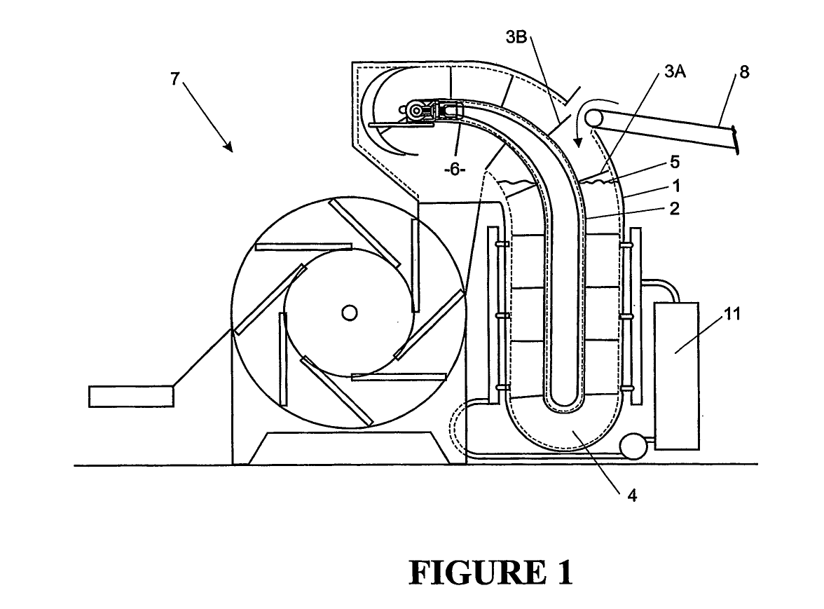

FIG. 2 is a perspective diagram shown with the bath containment transparent (for east of explanation) showing the inter-relationship of the components.

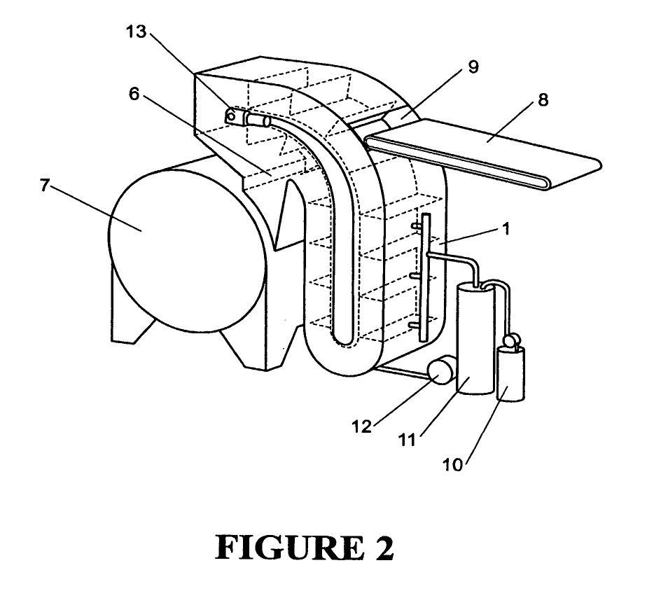

### BEST MODE FOR CARRYING OUT THE INVENTION

In the preferred form of the present invention a bath 1 defined by liquid in the lower part, the reservoir, of a generally inverted “j” or banana shaped containment (both inner and outer walls) has descending there into a series of flights 3A, 3B, etc. carried by a motor/gearbox driven endless belt conveyor such that apple slices, onion slices or other materials may be fed into the encompassment of the bath 1 but above the liquid level shown as 5 so as to be supported on a flight 3A (on one side) prior to that moving downwardly below the liquid thereby floating the apple pieces on the liquid until such time as the following flight 3B (by its side facing flight 3A) forces the materials downwardly around the bottom 4 of the bath before uplifting the materials with the flight 3B to the discharge zone 6 from whence the immersed materials cascade into any subsequent collection or subsequent treatment apparatus.

The flights (e.g. 3A, 3B et al.) are preferably perforated slats (or a mesh or mesh including) to ensure the immersed product can freely drain back to the bath prior to discharge.

The belt itself need not be perforated but can be (e.g. a mesh).

As shown, by example, is a paddle wheel arrangement 7 for a subsequent treatment solution.

A process that might be utilised is an apple or other treatment regime substantially as disclosed in the aforementioned Patent Specification of HortResearch or which may be a treatment regime such as disclosed by various Mantrose Haueser Company patent (e.g. U.S. Pat. Nos. 5,925,395 and 5,939,117).

As shown in the drawings an infeed conveyor 8 is provided to feed to the loading zone 9 between flights whilst the liquid level of the liquid 5 in the inverted ‘j’ shaped bath (both that shape for the inner and the outer walls so as to provide a better guide for the belt) is maintained reliant upon a dosage tank 10 feeding through a heat exchanger 11 communicating by a pump system 12 with the bath 1. As separate liquid can be provided in any subsequent treatment apparatus such as the paddle arrangement shown in 7.

Persons skilled in the art will appreciate the speed control applicable (dependent on treatment needs) for the motor/gearbox 13 (e.g. providing variable speed drive to allow different immersion times) and for relativity with any previous and following processing the variations that exist for arrangements as aforesaid.

Materials by which the conveyor system and surrounds can be made are of any suitable material that can handle the stress of the environment and usage as well as provides such acceptability as is required for what are preferably food grade items. Envisaged therefore as suitable materials are food grade plastics materials (e.g. PVC, RMV, NITRILE, HDPE, etc.), food grade rubber or synthetic rubber materials, food grade or other metals (e.g. stainless steel) as well as for non-food and/or bath contacting surfaces any suitable acceptable structural or manufacturing material (e.g. mild steel, plastic, etc.).

The control systems and drives are of any acceptable kind and will be well known to persons skilled in the conveying art and/or food processing industries.

1. Apparatus for immersing material or materials (“material(s)”) in a bath, said material(s), said apparatus comprising or including
a reservoir containing or to contain a liquid as said bath,
a flighted endless conveyor that serially present flights to a loading zone where each flight serially flight receives thereon material(s) to be immersed in the liquid of the bath and later presents material(s) initially received by the preceding flight to a discharge zone from whence the material(s) leave the flight,
wherein the loading zone to discharge zone involves an initial flight supported lowering of the materials down to the bath and thereafter a following flight carriage of the material(s) and/or liquid in the bath until such time as the materials are supported by said following flight out of the liquid of the bath and carried at least in part thereby to the discharge zone at which the materials cascade from said following flight.

2. The apparatus of claim 1 wherein said liquid is one in which said material(s) is (are) buoyant.

3. The apparatus of claim 1 wherein the discharge zone involves a gravity supported cascading of the materials from said following flight to a separate liquid to that of said bath.

4. The apparatus of claim 1 wherein each flight at least substantially completely occludes a passageway through the bath defined by the conveyor and the reservoir.

5. The apparatus of claim 1 wherein the locus of movement of the endless conveyor is that of an inverted conveyor preferably substantially in the form of an inverted “j”, the loading zone being at a region beyond the crook of the inverted “j” down which the flights move substantially on a vertical locus prior to ascending on the opposite side of the stem of the “j” and then into the overhang zone of the inverted “j” at which there is the discharge zone.

6. The apparatus of claim 1 wherein the locus of movement of the endless conveyor is such that there is in use a vertical or near vertical descending from the loading zone, irrespective of whether or not there is a vertical or near vertical ascending from the lower most zone and irrespective of whether or not there is any overhand (and irrespective of any concavity or not in the locus).

7. The apparatus of claim 1 substantially as hereinbefore described with reference to one or both of the accompanying drawings.

8. The use of a flighted endless conveyor for the purpose of immersing materials in a bath.

9. The use of claim 8 wherein the materials are buoyant in the liquid of the bath and an underside of flights of the conveyor lowers the materials in the liquid.

10. The use of a flighted endless conveyor for the purpose of immersing materials in a bath using apparatus of claim 1.

11. The use of claim 8 wherein the immersion is of apple pieces during a process as disclosed in PCT/NZ02/00168.

12. The use of claim 8 wherein the bath periphery conforms at least in part to those regions of the conveyor that are to lower the materials into, to carry the materials through, and uplift the materials from, the liquid of the bath.

13. The use of apparatus of claim 1 for the purpose of dipping vegetable and/or fruit material in an appropriate dipping solution.

14. (canceled)

15. (canceled)

16. A method of treating vegetable and/or fruit materials which comprises or includes immersing the materials in a treating liquid under the action of a flighted endless belt conveyor.

17. The method of claim 16 wherein an underside of one flight contacts, during at least an initial part of the immersion process in a bath, at least some of the materials which prior to immersion were lowered on the upperside of the flight preceding said one flight.

18. The materials treated by a method of treating vegetable and/or fruit materials which comprises or includes immersing the materials in a treating liquid under the action of a flighted endless belt conveyor, apparatus of claim 1 or a use of a flighted endless conveyor for the purpose of immersing materials in a bath.
